(19) United States
(12) Patent Application Publication
(10) Pub. No.: US 2013/0227819 A1
(43) Pub. Date: Sep. 5, 2013

(54) HINGE

(71) Applicants: Manfred Johannes Frank, Clevedon (NZ); Michael Gordon Graham, Bombay (NZ); Michael Kevin Scheib, Remuera (NZ)

(72) Inventors: Manfred Johannes Frank, Clevedon (NZ); Michael Gordon Graham, Bombay (NZ); Michael Kevin Scheib, Remuera (NZ)

(73) Assignee: MANFRED FRANK PATENT HOLDINGS LIMITED, Clevedon, Papakura (NZ)

(21) Appl. No.: 13/816,204

(22) PCT Filed: Aug. 5, 2011
(86) PCT No.: PCT/IB11/53495

§ 371 Date: May 23, 2013

(30) Foreign Application Priority Data
Aug. 9, 2010 (NZ) 587275

(51) Int. Cl. E05D 3/16

(52) U.S. Cl. CPC E05D 3/16
USPC 16/369; 74/96

(57) ABSTRACT

An articulating assembly of or for an adjustable hinge assembly, the articulating assembly comprising or including a height control arm supporting a mounting element at its distal end and pivotable about its proximal end for height adjustment, a convex member or members (“member(s)”) at or adjacent the distal region of the height control arm defining a distinct or merged pair of convex surfaces, the convex member(s) having a passageway therethrough, a pair of concave members engaged with the convex surfaces of the convex member(s) in a cupping manner, the concave members each having a passageway therethrough, and a pin located through the aligned passageways of the convex member(s) and concave members, the pin also being engaged with the mounting element to couple the mounting element to the height control arm, wherein the pin is dimensioned such that there is a clearance with respect to the passageway of the convex member(s) to allow at least limited articulating movement of the mounting element relative to the height control arm.

### FIELD OF THE INVENTION

The present invention relates to hinges. More particularly but not solely it relates to poly-axial hinges of a kind shown on our website www.manfredfrank.com. The full contents of which, as at 9 Aug. 2010, is hereby included by way of reference.

### BACKGROUND OF THE INVENTION

International patent specifications WO2006/062415 and WO1999/07260 describe adjustable, poly-axial hinges as in the aforementioned website.

WO2006/062415 in particular describes a poly-axial hinge in which height adjustment of the mounting element is facilitated by adjusting the height of the distal region of an arm (to which the mounting element is connected) relative to the proximal region of the arm. Articulation of the mounting element relative to the arm is necessary because the distal region of the arm is adjusted angularly with respect to the proximal region of the arm. Therefore articulation of the mounting element allows for correct orientation of a panel or similar object to which the mounting element is mounted. Poly-axial hinges may also be used to support building facades. Wind loading and pressure changes on facade panels can cause stress on the panel if it is mounted rigidly. Therefore there is need for articulation of the mounting element to compensate for slight movement of the panel due to such wind loading, pressure changes. An effective means for facilitating articulation of the mounting element is important while also being maintenance free and suitable for high cycle applications.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of the present invention to provide an improved hinge or hinge assembly which overcomes or at least partially ameliorates some of the abovementioned disadvantages or which at least provides the public with a useful choice.

It is a further or alternative object of the present invention to provide an articulating assembly which allows a limited degree of articulation in at least one plane and which can be useful in any one of a number of different applications including in a poly-axial hinge.

It is a further or alternative object to provide poly-axial hinges for high frequency use over a prolonged period.

### BRIEF DESCRIPTION OF THE INVENTION

The present invention relates to an improved mode of articulation for the distal region of an arm (preferably a bifurcated arm or forked arm) to better allow at least a small amount of articulation responsive to any height adjustment movement of the arm post installation.

In a first aspect the present invention consists in an articulating assembly of or for
an adjustable hinge assembly, the articulating assembly comprising or including:
   a height control arm supporting a mounting element at its distal end and pivotable about its proximal end for height adjustment,
   a convex member or members (“member(s)”) at or adjacent the distal region of the height control arm defining a distinct or merged pair of convex surfaces, the convex member(s) having a passageway therethrough,
   a pair of concave members engaged with the convex surfaces of the convex member(s) in a cupping manner, the concave members each having a passageway therethrough, and
   a pin located through the aligned passageways of the convex member(s) and concave members, the pin also being engaged with the mounting element to couple the mounting element to the height control arm,
   wherein the pin is dimensioned such that there is a clearance with respect to the passageway of the convex member(s) to allow at least limited articulating movement of the mounting element relative to the height control arm.

Preferably one convex member defines a distinct pair of convex surfaces.

Preferably the pin, mounting element and concave members are coupled together in a substantially fixed relationship.

Preferably the concave members can move relative to the convex surfaces due to the clearance between the pin and the passageway of the convex member(s).

Preferably the concave members and convex surfaces are shaped to be complementary with one another to allow for efficient force transfer between the concave members and the convex member irrespective of the position of the concave members relative to the convex surfaces.

Preferably the complementary shape of the concave members and convex surfaces enables force transfer in a non point-loading manner. Preferably the height control arm is pivotally coupled at its proximal end to an arm of the hinge.

Preferably the height control arm is located substantially within a bifurcated portion of the arm of the hinge.

Preferably adjustment of the height control arm is facilitated by a height adjusting screw threadingly associated with the arm of the hinge.

Preferably two height adjusting screws are provided, one each side of the height control arm.

Preferably the height adjusting screws abut the height control arm such that adjustment of the screws may adjust the angular position of the height control arm relative to the arm of the hinge.

In another aspect the present invention consists in a poly-axial hinge comprising or including:
a first arm pivotally coupled to and supporting a mounting element at its first end,
a second arm pivotally engaged in an scissoring manner with the first arm, and pivotally coupled to a mounting plate at its first end,
a first link pivotally coupled at its first end to the mounting element and pivotally coupled at its second end to the second end of the second arm, and
a second link pivotally coupled at its first end to the mounting plate and pivotally coupled at its second end to the second end of the first arm,
wherein the or each coupling between
(i) the first end of the first arm and the mounting element, and/or,
(ii) the first end of the first link and the mounting element and/or,
(iii) the second end of the first link and the second end of the second arm,
incorporates complementary convex and concave members engaged with one another and movable with respect to one another to facilitate slight articulation between the two parts being coupled.

Preferably the first arm is formed in two parts comprising of a height control arm which is pivotally coupled to a main arm portion.

Preferably the height control arm is located at the first end of the first arm and is coupled to the mounting element.

Preferably the height control arm is pivotally coupled at its proximal end to the first arm and is coupled to the mounting element at its distal end.

Preferably the height control arm is located substantially within a bifurcated portion of the main arm portion.

Preferably the angular position of the height control arm with respect to the main arm portion can be adjusted by a height adjusting screw threadingly associated with the main arm portion.

Preferably two height adjusting screws are provided, one each side of the height control arm.

Preferably the height adjusting screws abut the height control arm such that adjustment of the screws may adjust the angular position of the height control arm relative to the arm of the hinge.

Preferably the convex member is located at or adjacent the distal region of the height control arm and defines a distinct pair of convex surfaces, the convex member having a passageway therethrough.

Preferably concave members are engaged with each convex surface in a cupping manner, the concave members having a passageway therethrough.

Preferably a pin is located through the aligned passageways of the convex member and concave members, the pin also being engaged with the mounting element to couple the mounting element to the height control arm,
and wherein the pin is dimensioned such that there is a clearance with respect to the passageway of the convex member to allow at least limited articulating movement of the mounting element relative to the height control arm.

Preferably the pin, mounting element and concave members are coupled together in a substantially fixed relationship.

Preferably the concave members can move relative to the convex surfaces due to the clearance between the pin and the passageway of the convex surfaces.

Preferably the concave members and convex surfaces are shaped to be complementary with one another to allow for efficient force transfer between the concave members and the convex surfaces irrespective of the position of the concave members relative to the convex surfaces.

Preferably the complementary shape of the concave members and convex surfaces enables force transfer in a non point-loading manner.

Preferably the mounting element can articulate sufficiently to accommodate likely height adjustments of the height control arm.

In another aspect the present invention consists in a multi-axis hinging mechanism having seven at least substantially parallel axes, two axes associated with a mounting element and another two axes associated with a mounting plate;
wherein an arm adjustable for height after the mounting plate is fixed carries the mounting element through an actual or simulated ball and socket support where aligned passageways have sufficient clearance on a pin of the ball and socket support to allow some adjustment of the mounting element's disposition.

Preferably the ball and socket support comprises complementary convex and concave members engaged with one another and movable with respect to one another to facilitate slight articulation between the mounting element and the arm.

Preferably the convex member is located at or adjacent a distal region of the arm and defines a distinct pair of convex surfaces, the convex member having a passageway therethrough.

Preferably concave members are engaged with each convex surface in a cupping manner, the concave members having a passageway therethrough.

Preferably the pin is located through the aligned passageways of the convex member and concave members, the pin also being engaged with the mounting element to couple the mounting element to the height control arm,
and wherein the pin is dimensioned such that there is a clearance with respect to the passageway of the convex member to allow at least limited articulating movement of the mounting element relative to the height control arm.

In another aspect the invention consists in a hinge assembly typified by that as disclosed as a poly-axial hinge on www.manfredfredfrank.com but where, to allow articulation of the mounting element, its height adjustment arm proximally of its pinned connection to the glass panel mounting element has an articulation provided by a ball in socket interface about the pin of the pinned connection.

In another aspect the present invention consists in a hinge as herein described with reference to any one or more of the accompanying drawings.

In another aspect the present invention consists in a hinge assembly as herein described with reference to any one or more of the accompanying drawings.

In another aspect the present invention consists in an articulating assembly as herein described with reference to any one or more of the accompanying drawings.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

For the purposes of this specification the term poly-axial hinge shall be construed to mean any hinge having multiple hinge members that articulate relative to one another about more than one axis. The hinges defined in international patent specifications WO2006/062415 and WO1999/07260 are examples of poly-axial hinges.

For the purposes of this specification the term frusto spherical shall be construed to mean an object that is shaped similar to the shape of a truncated sphere however can include shapes beyond those that are strictly “frusto spherical”.

For the purposes of this specification the terms link, linkage or similar shall be construed to mean any linking member irrespective of any tension or compressive forces transferred by the member.

The entire disclosures of all applications, patents and publications, cited above and below, if any, are hereby incorporated by reference.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 is a perspective view of a poly-axial hinge,

FIG. 2 is a side view of the hinge of FIG. 1,

FIG. 3 is a side view of a poly-axial hinge in a first position,

FIG. 4 is a side view of the poly-axial hinge of FIG. 3 in a second position,

FIG. 5 is a side view of the poly-axial hinge of FIG. 3 in a third position,

FIG. 6 is a side view of the poly-axial hinge of FIG. 3 in a fourth position,

FIG. 7 is a side view of the poly-axial hinge of FIG. 3 in a fifth position,

FIG. 8 is a perspective view of an arm of a poly-axial hinge with a pivotable height adjustment link arm coupled thereto,

FIG. 9 is a top view of the arm and height adjustment link arm of FIG. 8,

FIG. 10 is a bottom view of the arm and height adjustment link arm of FIG. 8,

FIG. 11 is an exploded view of a hinge showing the subassembly that allows the mounting plate freedom to articulate with respect to the hinge,

FIG. 12 is a side view of a hinge showing the location of the cross section A-A,

FIG. 13 is a perspective view of the hinge of FIG. 12,

FIG. 14 shows the cross section A-A of FIG. 12, and

FIG. 15 shows a hinge with “ball and cup” type joints located at both ends of the adjustable link 24.

### DETAILED DESCRIPTION OF THE INVENTION

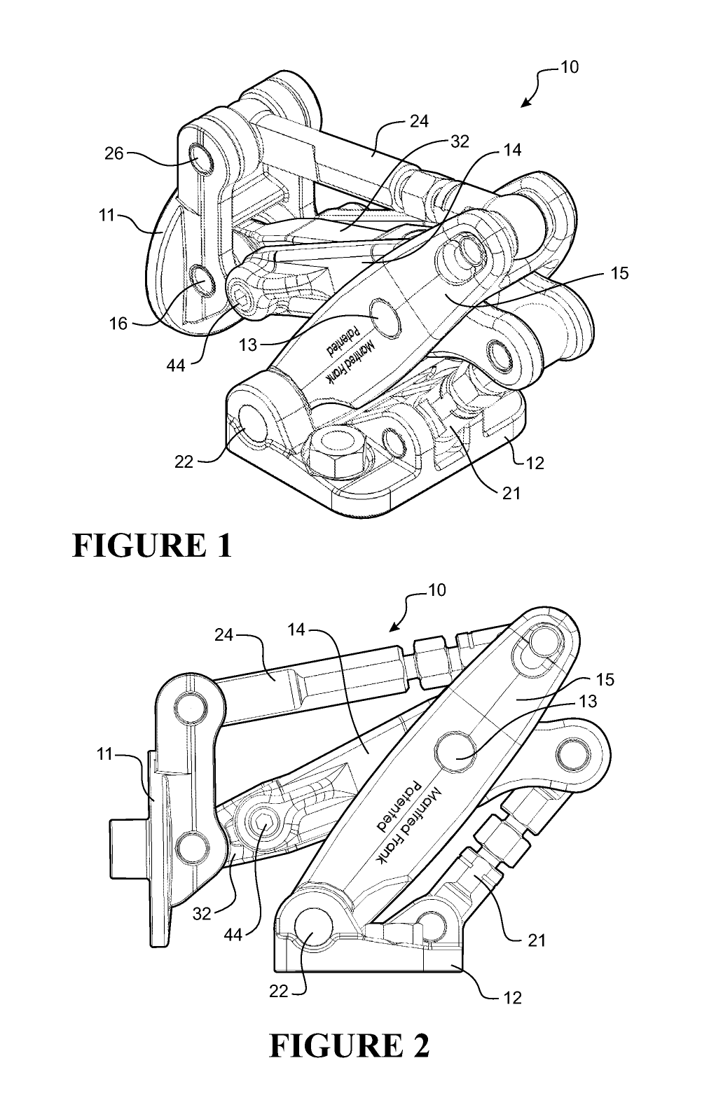

With reference to FIGS. 1 and 2 a poly-axial hinge 10 is shown. The hinge 10 may be suitable for mounting to a fixed frame or other structural element via the frame mounting plate 12 Likewise, the hinge 10 may be suitable for mounting to a panel, window, door or other moveable object via the closure mounting element 11. It may also be suite mounting to a stationary object like a building facade via mounting element 11. It should be appreciated that the hinge of the present invention may be suitable for any other applications including but not limited to the architectural industry, the marine industry, the transport industry, the aircraft industry.

Mounting the hinge 10 to a fixed frame or other structural element via the mounting plate 12 can be achieved by the use of screws, bolts or other fasteners as would be apparent to a person skilled in the art.

Mounting the hinge 10 to a panel, window, door or other moveable object (or to a stationary object) via the mounting element 11 may be achieved in any way as would be apparent to a person skilled in the art. For example, a glass panel may be mounted by clamping the panel between the mounting element 11 and a clamping member.

Once mounted, the hinge 10 is adjustable in a number of directions in order to locate the panel, window, door or other object in the desired position. This type of hinge 10 is described in international patent specification WO2006/062415 (the contents of which are hereby incorporated by reference). The hinge is a poly-axial hinge. More specifically, it includes seven axes.

The hinge 10 includes a first arm 14 and a second arm 15 pivotally coupled together via a pin 13. The first arm 14 is pivotally coupled to the mounting element 11 via link arm 32 Likewise the second arm 15 is pivotally coupled via pin 22 to the mounting plate 12. Link arm 32 is pivotally coupled to the first arm 14 at its proximal end and is adjustable to control the height of the mounting element 11 which is articulatable with respect to its distal end.

Adjustable links 21 and 24 are provided to couple the arms 13 and 15 to mounting element 11 and mounting plate 12 respectively.

The function and adjustability of the hinge 10 is described, in depth, in international patent specifications WO2006/062415 and WO1999/07260.

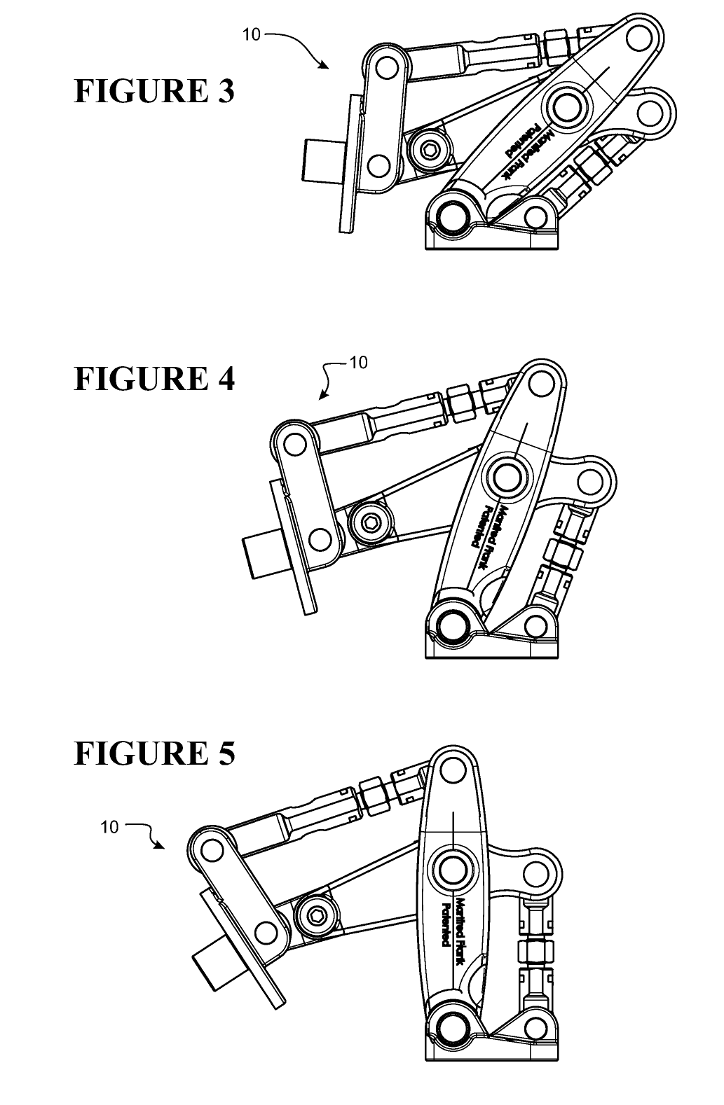

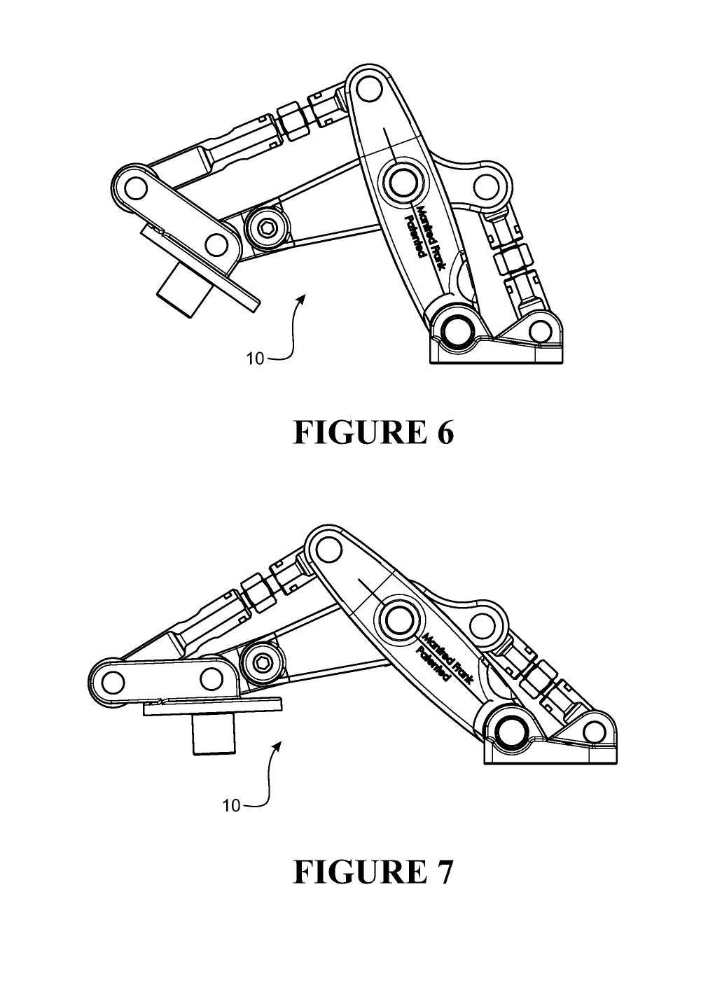

FIGS. 3 to 7 show a poly-axial hinge 10 moving through a range of motions from a first extreme position (FIG. 3) to a second extreme position (FIG. 7).

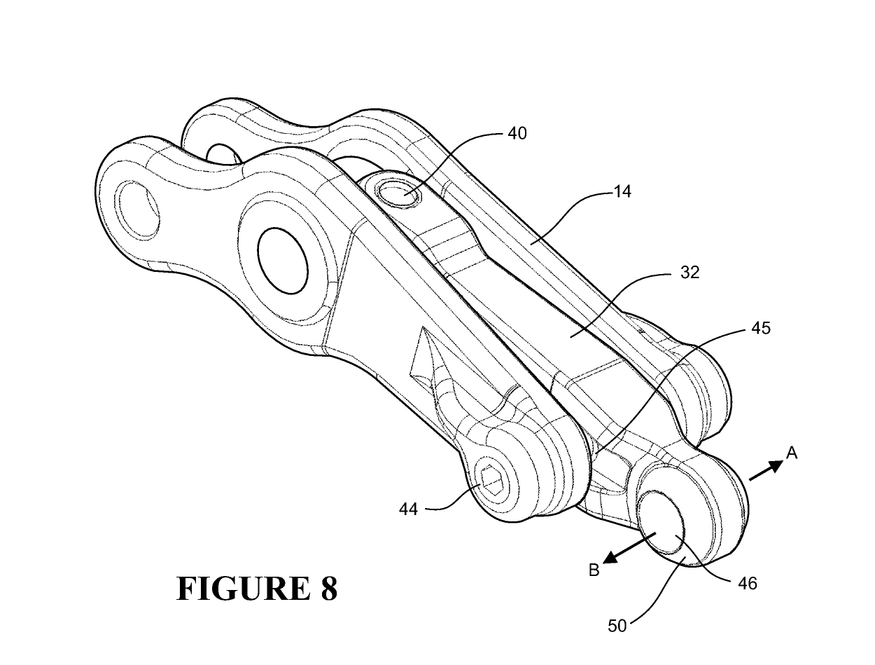

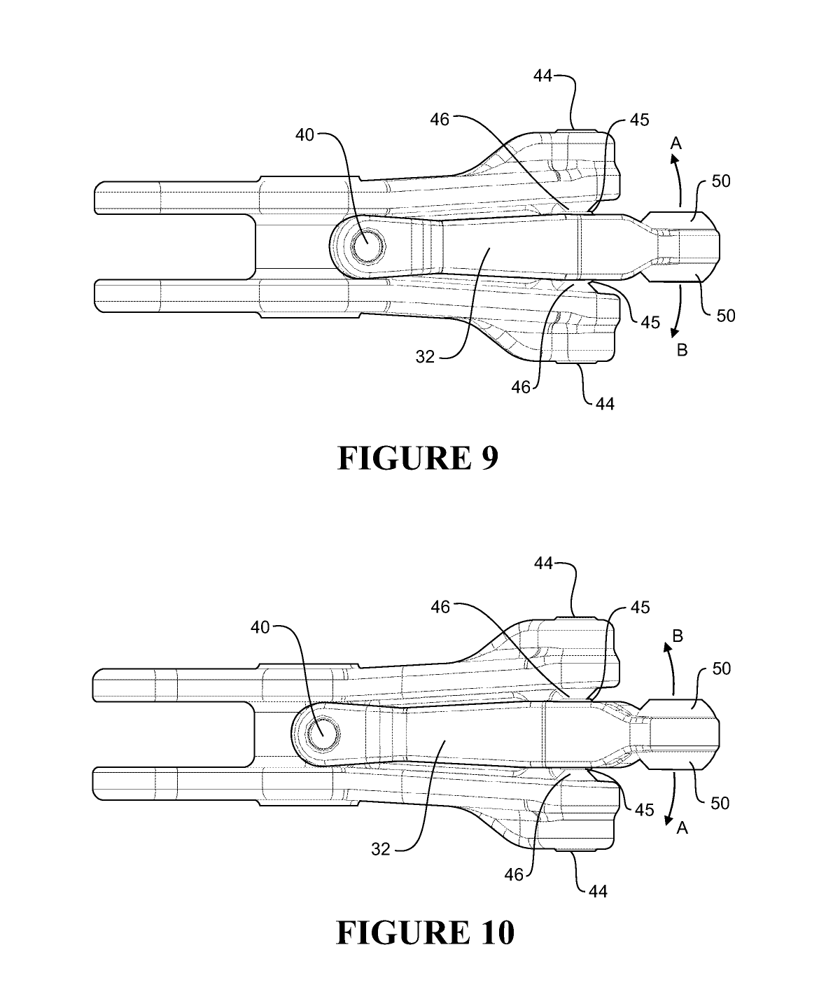

The hinge of the present invention can be fully adjusted post installation. Height adjustment is facilitated via adjustment of the link arm 32. The link arm 32 is pivotally coupled to the first arm 14 via a pivot pin 40. The link arm 32 is able to pivot about the pivot pin 40 to enable movement in the directions indicated by arrows A and B as shown on FIGS. 8-10. Movement in the directions A and B results in movement of the mounting element 11 in a vertical direction and therefore vertical movement of any panel, window, door or other moveable object mounted to the mounting element 11.

Adjustment of the position of the link arm 32 is facilitated by height adjusting screws 44 which have tips 46 that may abut the surfaces 45 on the link arm 32. The surfaces 45 provide a surface for the tips 46 to bear on. The orientation of the longitudinal axis of the screws 44 is substantially perpendicular to the surfaces 45.

In an alternative embodiment the surfaces 45 may be profiled to be complementary to the shape of the tip 46 of the adjustment screws 44 to avoid point loading.

Referring to FIGS. 8-10 it will be appreciated that by adjusting the pair of height adjusting screws 44, the position of the link arm 32 relative to the arm 31 can be adjusted annularly about the pivot 40. This movement causes vertical (height adjustment) of the mounting element 11 when the hinge 10 is in use.

Optionally the height adjusting screws may be locked into place by a nylon locking element 60. As shown on FIG. 13 a locking element may be inserted into the slot 61. The locking element 60 may have an aperture therethough slightly smaller than the size of the height adjusting screw 44 to which it is associated. When the height adjusting screw is adjusted into the desired position, the nylon locking element will deter the screw 44 from further movement.

In the instance where the hinge may be manufactured from plastic, such as that shown in FIG. 1, a nylon locking element 60 may not be required to deter the screw 44 from further movement. The tap in the hinge body may be slightly undersized so that the screw 44 is held tightly and will not move, once in the desired position.

Due to the annular movement of the link arm 32, the mounting element 11 must be able to articulate so that it can compensate for a non-vertical orientation caused by angular adjustment of the link arm 32. Articulation of the mounting element 11 ensures that the plane of the mounting element 11 can stay parallel to the vertical plane when the link arm 32 is angularly adjusted. If the mounting element 11 could not articulate with respect to the link arm 32 then the panel, door, or similar which is being held by the mounting element 11 could not remain in the vertical plane through the entire movement range of the link arm 32. Slight articulation of the mounting element 11 with respect to the link arm 32 is therefore essential to ensure proper orientation of the panel, door or similar that is being held by the mounting element 11.

The hinge 10 may also be used to support objects such as glass panels for building facades or other similar installations either external or internal of a building. Panels for external building facades are subjected to wind loading and pressure changes. This puts stress on the panel if it is mounted rigidly. The ability for the mounting element 11 of the hinge 10 to articulate is important for building facade applications. Slight articulation of the mounting element 11 is necessary so that the panel can move slightly in response to wind loading, pressure changes etc.

The hinge of the present invention is suited to building facade applications because of its ability to provide continuous peripheral venting of a panel to which it is mounted. Such venting is important for some facade applications. Smoke ventilation can also be facilitated by a panel supported by a plurality of hinges 10. Drive mechanisms can be used to facilitate the opening and closing of individual panels or an array of panels.

The present invention provides an effective means for facilitating articulation of the mounting element while also being maintenance free and suitable for high cycle applications.

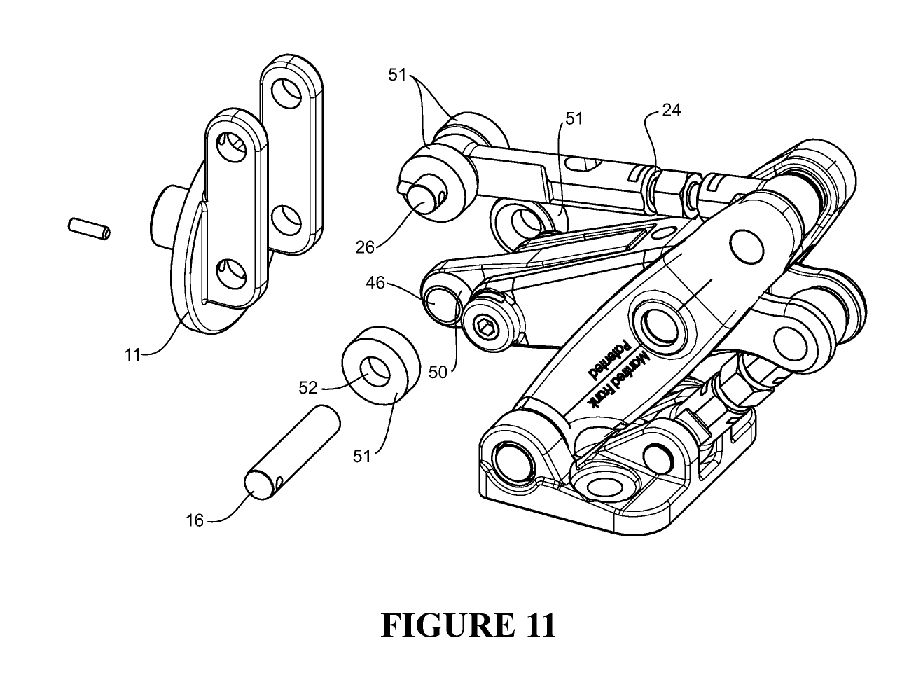

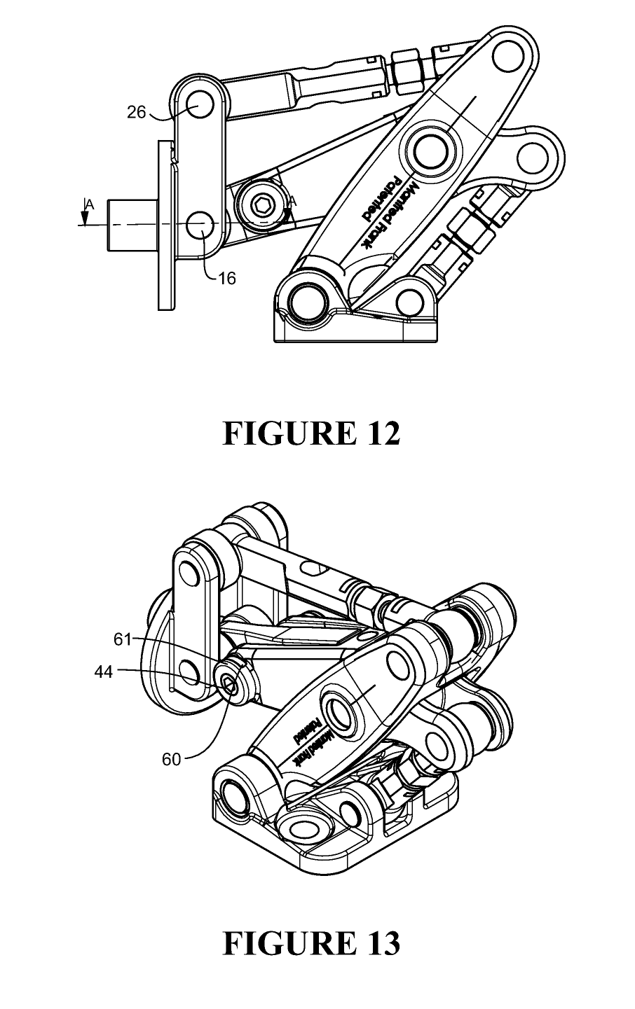

The mounting element 11 is coupled to the first arm 14 via link arm 32. It is also coupled to arm 15 via adjustable link 24. The mounting element 11 pivots with respect to the first arm 14 about pin 16 and pivots with respect to the adjustable link 24 about pin 26. An exploded view of this sub-assembly is shown with respect to FIG. 11. The pin 16 may be coupled to the mounting plate 11 via swaging or any other suitable means.

The link arm 32 has two outwardly projecting convex surfaces 50 at its distal end. The convex surfaces 50 may be frusto spherical in shape. The distal end of the link arm 32 has a bore 46 therethrough, which is aligned with the two outwardly projecting convex surfaces 50. The bore 46 provides a passage for the pin 16 to engage to lock the mounting element 11 to the link arm 32.

The assembly includes two cup members 51 located either side of the distal region of the link arm 32 and corresponding with the convex surfaces 50. The cup members 51 and the convex surfaces 50 engage one another in a complementary manner, analogous to a ball and cup joint.

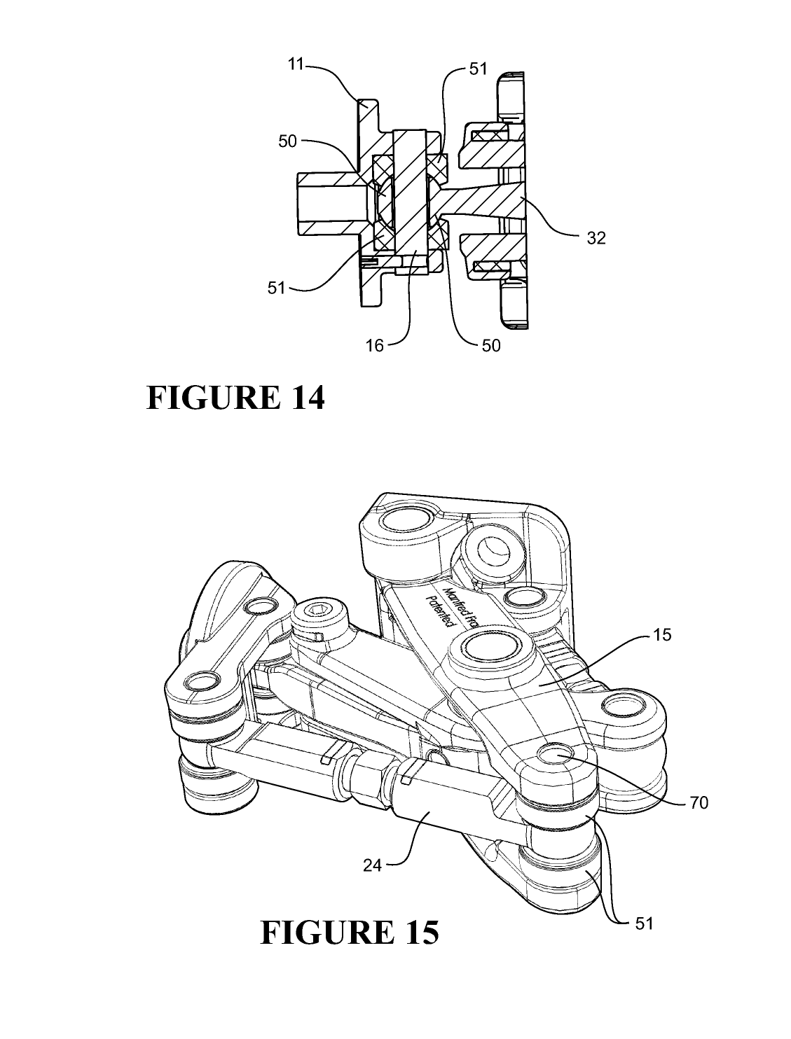

The cups 51 have an internal bore 52 therethrough which corresponds with the diameter of the pin 16. However there is a clearance fit between the bore 46 of the link arm 32 and the pin 16 as shown on FIG. 14. This clearance fit enables the pin 16 and cups 51 (and therefore the mounting element 11) to move slightly, relative to the link arm 32. This enables slight articulation of the mounting element 11. The complementary fit between the outwardly projecting convex surfaces 50 and the cup members 51 enables the slight articulation and is effective in transferring force between the components. The curved surfaces between the surfaces 50 and the cup members 51 provides a greater area for force transfer, this force transfer interface deters force from being transferred in a point loading manner. This is especially important to increase the longevity of the hinge. Point loading of the components can result in wear and tear when used in high cycle applications.

The connection between the adjustable link 24 and the mounting element 11 may be the same as described above with respect to the connection between the link arm 32 and the mounting element 11. The distal end of the adjustable link 24 may have two outwardly projecting convex surfaces 50 which engage with cup members 51.

Therefore the connection between the adjustable link 24 and the mounting element 11 can also facilitate articulation of the mounting element 11. This assembly ensures freedom to articulate sufficiently to accommodate likely height adjustments of the link arm 32 when the hinge 10 is mounted to a fixed structure via the mounting plate 12 and a panel, window, door or other moveable object via the mounting element 11.

With reference to FIG. 15, the connection at the other end of the adjustable link 24 may also utilise a “ball and cup” arrangement as described above with reference to the connection arrangement between the link arm 32 and the mounting element 11. In such a configuration, outwardly projecting convex surfaces 50 may be present on the proximal end of the adjustable link 24. Cup members 51 are provided to engage with the convex surfaces 50. A pin 70 is provided to tie the proximal end of the adjustable link 24 and the cup members 51 to the second arm 15 and shown in FIG. 15. Such an arrangement facilitates articulation of the adjustable link 24 relative to the second arm 15.

It should be appreciated that the “ball and cup” connections consisting of outwardly projecting convex surfaces 50 and complementary cup members 51 may be present between various linkages of the hinge. Such connections allow for some degree of articulation between parts of the hinge, and especially promote articulation of the mounting element 11.

The components of the hinge of the present invention may be manufactured from steel or from any other suitable materials such as plastic or composite materials such as glass-fibre reinforced nylon.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. An articulating assembly of or for an adjustable hinge assembly, the articulating assembly comprising or including:
a height control arm supporting a mounting element at its distal end and pivotable about its proximal end for height adjustment,
a convex member or members (“member(s)”) at or adjacent the distal region of the height control arm defining a distinct or merged pair of convex surfaces, the convex member(s) having a passageway therethrough,
a pair of concave members engaged with the convex surfaces of the convex member(s) in a cupping manner, the concave members each having a passageway therethrough, and
a pin located through the aligned passageways of the convex member(s) and concave members, the pin also being engaged with the mounting element to couple the mounting element to the height control arm,
wherein the pin is dimensioned such that there is a clearance with respect to the passageway of the convex member(s) to allow at least limited articulating movement of the mounting element relative to the height control arm.

2. An articulating assembly as claimed in claim 1 wherein one convex member defines a distinct pair of convex surfaces.

3. An articulating assembly as claimed in claim 1 wherein the pin, mounting element and concave members are coupled together in a substantially fixed relationship.

4. An articulating assembly as claimed in claim 2 wherein the concave members can move relative to the convex surfaces due to the clearance between the pin and the passageway of the convex member(s).

5. An articulating assembly as claimed in claim 2 wherein the concave members and convex surfaces are shaped to be complementary with one another to allow for efficient force transfer between the concave members and the convex member irrespective of the position of the concave members relative to the convex surfaces

6. (canceled)

7. An articulating assembly as claimed in claim 1 wherein the height control arm is pivotally coupled at its proximal end to an arm of the hinge.

8. An articulating assembly as claimed in claim 7 wherein the height control arm is located substantially within a bifurcated portion of the arm of the hinge.

9. An articulating assembly as claimed in claim 8 wherein adjustment of the height control arm is facilitated by a height adjusting screw threadingly associated with the arm of the hinge, and
wherein the height adjusting screws abut the height control arm such that adjustment of the screws may adjust the angular position of the height control arm relative to the arm of the hinge.

10-11. (canceled)

12. A poly-axial hinge comprising or including:
a first arm pivotally coupled to and supporting a mounting element at its first end, wherein the first arm is formed in two parts comprising of a height control arm which is pivotally coupled to a main arm portion,
a second arm pivotally engaged in an scissoring manner with the first arm, and pivotally coupled to a mounting plate at its first end,
a first link pivotally coupled at its first end to the mounting element and pivotally coupled at its second end to the second end of the second arm, and
a second link pivotally coupled at its first end to the mounting plate and pivotally coupled at its second end to the second end of the first arm,
wherein the or each coupling between
the first end of the first arm and the mounting element, and/or,
the first end of the first link and the mounting element and/or,
the second end of the first link and the second end of the second arm,
incorporates complementary convex and concave members engaged with one another and movable with respect to one another to facilitate slight articulation between the two parts being coupled.

13-14. (canceled)

15. A poly-axial hinge as claimed in claim 12 wherein the height control arm is pivotally coupled at its proximal end to the first arm and is coupled to the mounting element at its distal end.

16. A poly-axial hinge as claimed in claim 12 wherein the height control arm is located substantially within a bifurcated portion of the main arm portion.

17. A poly-axial hinge as claimed in claim 16 wherein the angular position of the height control arm with respect to the main arm portion can be adjusted by a height adjusting screw threadingly associated with the main arm portion, and
wherein the height adjusting screws abut the height control arm such that adjustment of the screws may adjust the angular position of the height control arm relative to the arm of the hinge.

18-19. (canceled)

20. A poly-axial hinge as claimed in claim 12 wherein the convex member is located at or adjacent the distal region of the height control arm and defines a distinct pair of convex surfaces, the convex member having a passageway therethrough.

21. A poly axial hinge as claimed in claim 20 wherein concave members are engaged with each convex surface in a cupping manner, the concave members having a passageway therethrough.

22. A poly-axial hinge as claimed in claim 21 wherein a pin is located through the aligned passageways of the convex member and concave members, the pin also being engaged with the mounting element to couple the mounting element to the height control arm,
and wherein the pin is dimensioned such that there is a clearance with respect to the passageway of the convex member to allow at least limited articulating movement of the mounting element relative to the height control arm.

23. A poly-axial hinge as claimed in claim 22 wherein the pin, mounting element and concave members are coupled together in a substantially fixed relationship.

24. A poly-axial hinge as claimed in claim 22 wherein the concave members can move relative to the convex surfaces due to the clearance between the pin and the passageway of the convex surfaces.

25. A poly-axial hinge as claimed in claim 22 wherein the concave members and convex surfaces are shaped to be complementary with one another to allow for efficient force transfer between the concave members and the convex surfaces irrespective of the position of the concave members relative to the convex surfaces.

26. (canceled)

27. A poly-axial hinge as claimed in claim 17 wherein the mounting element can articulate sufficiently to accommodate likely height adjustments of the height control arm.

28-34. (canceled)
